(19) United States
(12) Patent Application Publication
(10) Pub. No.: US 2007/0252879 A1
(43) Pub. Date: Nov. 1, 2007

(54) PHASE CHANGE INK ADDITIVES

(75) Inventors: Jeffrey H. Banning, Hillsboro, OR (US); Wolfgang G. Wedler, Tualatin, OR (US)

Correspondence Address: OLIFF & BERRIDGE, PLC., P.O. BOX 19928, ALEXANDRIA, VA, 22320, US

(73) Assignee: Xerox Corporation, Stamford, CT (US)

(21) Appl. No.: 11/380,788

(22) Filed: Apr. 28, 2006

(51) Int. Cl. G01D 11/00; C09D 11/00

(52) U.S. Cl. 347/99; 106/31.29; 106/31.61; 106/31.32; 106/31.64; 106/31.3; 106/31.62; 106/31.35; 106/31.67; 106/31.41; 106/31.73; 106/31.43; 106/31.75

(57) ABSTRACT

A phase change ink having an ink vehicle and a conductivity enhancing agent. The conductivity enhancing agent may be an organic salt derived from an organic base having at least one long hydrocarbon chain and an acid. The inks described herein have a consistent electrical conductivity and may be used as an input signal for an ink reservoir level sensing in ink jet devices.

### BACKGROUND

Described herein are inks such as solid phase change or hot melt inks that have a consistent electrical conductivity and may be used as an input signal for an ink reservoir level sensing in ink jet devices.

The phase change ink compositions illustrated herein in embodiments are solid at room temperature, for example from about 20° C. to about 27° C., and are suitable for ink jet printing processes, particularly piezoelectric and acoustic ink jet printing processes.

In embodiments, the phase change inks disclosed herein include a conductivity enhancing agent with a benefit that the agent imparts a consistent conductivity to the ink without damaging any printer parts, for example, printer parts found in the print heads or the reservoir of an ink jet device. The conductivity enhancing agent may be an organic salt derived from a long carbon chain organic base and an acid having a molecular weight of from about 25 to about 250.

### REFERENCES

Ink jetting devices are well known in the art. As described in U.S. Pat. No. 6,547,380, the disclosure of which is totally incorporated herein by reference, ink jet printing systems are generally of two types: continuous stream and drop-on-demand. In continuous stream ink jet systems, ink is emitted in a continuous stream under pressure through at least one orifice or nozzle. The stream is perturbed, causing it to break up into droplets at a fixed distance from the orifice. At the break-up point, the droplets are charged in accordance with digital data signals and passed through an electrostatic field that adjusts the trajectory of each droplet in order to direct it to a gutter for recirculation or a specific location on a recording medium. In drop-on-demand systems, a droplet is expelled from an orifice directly to a position on a recording medium in accordance with digital data signals. A droplet is not formed or expelled unless it is to be placed on the recording medium. There are generally three types of drop-on-demand ink jet systems. One type of drop-on-demand system is a piezoelectric device that has as its major components an ink filled channel or passageway having a nozzle on one end and a piezoelectric transducer near the other end to produce pressure pulses. Another type of drop-on-demand system is known as acoustic ink printing. As is known, an acoustic beam exerts a radiation pressure against objects upon which it impinges. Thus, when an acoustic beam impinges on a free surface (i.e., liquid/air interface) of a pool of liquid from beneath, the radiation pressure which it exerts against the surface of the pool may reach a sufficiently high level to release individual droplets of liquid from the pool, despite the restraining force of surface tension. Focusing the beam on or near the surface of the pool intensifies the radiation pressure it exerts for a given amount of input power. Still another type of drop-on-demand system is known as thermal ink jet, or bubble jet, and produces high velocity droplets. The major components of this type of drop-on-demand system are an ink filled channel having a nozzle on one end and a heat generating resistor near the nozzle. Printing signals representing digital information originate an electric current pulse in a resistive layer within each ink passageway near the orifice or nozzle, causing the ink vehicle (usually water) in the immediate vicinity to vaporize almost instantaneously and create a bubble. The ink at the orifice is forced out as a propelled droplet as the bubble expands.

In a typical design of a piezoelectric ink jet device, the image is applied by jetting appropriately colored inks during four to eighteen rotations (incremental movements) of a substrate such as an image receiving member or intermediate transfer member with respect to the ink jetting head, i.e., there is a small translation of the printhead with respect to the substrate in between each rotation. This approach simplifies the printhead design, and the small movements ensure good droplet registration. At the jet operating temperature, droplets of liquid ink are ejected from the printing device. When the ink droplets contact the surface of the recording substrate, either directly or via an intermediate heated transfer belt or drum, they quickly solidify to form a predetermined pattern of solidified ink drops. Phase change ink jet processes are well known and are described, for example, in U.S. Pat. Nos. 4,601,777, 4,251,824, 4,410,899, 4,412,224 and 4,532,530, the disclosures of each of which are totally incorporated herein by reference.

Ink jet printing processes may employ inks that are solid at room temperature and liquid at elevated temperatures. Such inks may be referred to as hot melt inks or phase change inks. For example, U.S. Pat. No. 4,490,731, the disclosure of which is totally incorporated herein by reference, discloses an apparatus for dispensing solid ink for printing on a substrate such as paper. In thermal ink jet printing processes employing hot melt inks, the solid ink is melted by the heater in the printing apparatus and utilized (i.e., jetted) as a liquid in a manner similar to that of conventional thermal ink jet printing. Upon contact with the printing substrate, the molten ink solidifies rapidly, enabling the colorant to substantially remain on the surface of the substrate instead of being carried into the substrate (for example, paper) by capillary action, thereby enabling higher print density than is generally obtained with liquid inks. Advantages of a phase change ink in ink jet printing are thus elimination of potential spillage of the ink during handling, a wide range of print density and quality, minimal paper cockle or distortion, and enablement of indefinite periods of nonprinting without the danger of nozzle clogging, even without capping the nozzles.

U.S. Pat. Nos. 5,006,170 and 5,122,187, the disclosures of each of which are totally incorporated herein by reference, disclose hot melt ink compositions suitable for ink jet printing which comprise a colorant, a binder, and a propellant.

U.S. Pat. No. 4,889,560, the disclosure of which is totally incorporated herein by reference, discloses a phase change ink carrier composition combined with a colorant to form a phase change ink composition.

U.S. Pat. No. 5,385,957, the disclosure of which is totally incorporated herein by reference, discloses a hotmelt ink comprising ionomers and an image-forming agent, wherein the melting point of the ionomers is from about 50° C. to about 130° C., and the ink exhibits, in its molten state, a viscosity from about 5 cP to about 60 cP at temperature of about 90° C. to 140° C.

U.S. Pat. Nos. 6,001,160 and 6,057,399, the disclosures of each of which are totally incorporated herein by reference, disclose phase change ink additives, which comprise quaternary ammonium salts.

U.S. Pat. No. 5,386,224, the disclosure of which is totally incorporated herein by references, discloses a discrete ink level sensing system that uses electrical conductivity of the ink to detect when the upper surface level of the ink is lower than the lowest points of the level sensing pads.

In ink jetting devices, the device may measure electrical conductivity of the phase change inks as an input signal representative of the ink reservoir level in the device. For example, during operation, the device may perform a constant comparison between measured ink conductivities and a specified value representative of an ink level. As a result of the comparison, liquefaction of additional ink amounts for re-supply to the reservoirs during the printing process is either started or stopped. Effectively, this mechanism may prevent overflow of ink reservoirs in the printers, which would otherwise damage sensitive printer parts.

### SUMMARY

In embodiments, described is a phase change ink having an ink vehicle and a conductivity enhancing agent, wherein the conductivity agent is an organic salt.

In further embodiments, described is an ink jet system, comprising at least one phase change ink having an ink vehicle and a conductivity enhancing agent, wherein the conductivity enhancing agent is an organic salt, and an ink jet device including an ink jet head consisting of one or more channels for the at least one phase change ink, and a supply path that supplies the at least one phase change ink to the one or more channels of the ink jet head from one or more reservoirs containing the at least one phase change ink, and wherein the one or more reservoirs include a sensor to measure conductivity of the at least one phase change ink therein.

In yet further embodiments, described is a process for making a phase change ink including an organic salt therein, comprising pre-melting an organic base, adding an acid to the pre-melted organic base such that a cation of the organic base reacts with a molecular ion of the acid to form the organic salt, separately melting an ink vehicle, and adding the organic salt to the melted ink vehicle.

### EMBODIMENTS

The phase change inks including an electrical conductivity enhancing agent also include an ink vehicle that is solid at temperatures of about 20° C. to about 27° C., for example room temperature, and specifically are solid at temperatures below about 40° C. However, the inks change phase upon heating, and are in a molten state at jetting temperatures. Thus, the inks have a viscosity of from about 1 to about 20 centipoise (cP), such as from about 5 to about 15 cP or from about 8 to about 12 cP, at an elevated temperature suitable for ink jet printing, such as temperatures of from about 50° C. to about 150° C.

In this regard, the inks herein may be low energy inks. Low energy inks are solid at a temperature below about 40° C. and have a viscosity of from about 5 to about 15 cP at a jetting temperature of from about 50° C. to about 150° C., such as from about 70° C. to about 120° C. or from about 80° C. to about 120° C. The inks jet at lower temperatures as above, and thus require lower amounts of energy for jetting.

Any suitable ink vehicle can be employed. Suitable vehicles can include paraffins, microcrystalline waxes, polyethylene waxes, ester waxes, fatty acids and other waxy materials, fatty amide containing materials, sulfonamide materials, resinous materials made from different natural sources (tall oil rosins and rosin esters, for example), and many synthetic resins, oligomers, polymers, and copolymers such as farther discussed below, and mixtures thereof.

Examples of suitable specific ink vehicles include, for example, ethylene/propylene copolymers, such as those available from Petrolite and of the general formula 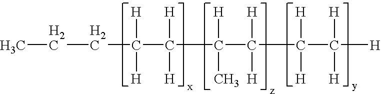
wherein z represents an integer from 0 to about 30, for example from 0 to about 20 or from 0 to about 10, y represents an integer from 0 to about 30, for example from 0 to about 20 or from 0 to about 10 and x is equal to about 21−y. The distribution of the side branches may be random along the carbon chain. The copolymers may have, for example, a melting point of from about 70° C. to about 150° C., such as from about 80° C. to about 130° C. or from about 90° C. to about 120° C. and a molecular weight range of from about 500 to about 4,000. Commercial examples of such copolymers include, for example, Petrolite CP-7 (Mn=650), Petrolite CP-11 (Mn=1,100, Petrolite CP-12 (Mn=1,200) and the like.

Urethane, urea, amide and imide derivatives of oxidized synthetic or petroleum waxes, such as those available from Petrolite and of the general formulas 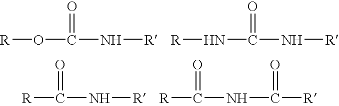
wherein R is an alkyl group of the formula CH₁(CH₂)ₙ, n is an integer of from about 5 to about 400, for example from about 10 to about 300 or from about 20 to about 200 and R′ is a tolyl group, may also be used as the ink vehicle. In embodiments, the urethane, urea, amide and imide derivatives may be linear, branched, cyclic and any combination thereof. These materials may have a melting point of from about 60° C. to about 120° C., such as from about 70° C. to about 100° C. or from about 70° C. to about 90° C. Commercial examples of such materials include, for example, PETROLITE CA-11 (Mn=790, Mw/Mn=2.2), PETROLITE WB-5 (Mn=650, Mw/Mn=1.7), PETROLITE WB-17 (Mn=730, Mw/Mn=1.8), and the like. Suitable examples also include urethane, urea, amide and imide derivatives disclosed in U.S. Pat. Nos. 6,620,228, 6,380,423, 6,464,766 and 6,309,453, each of which is incorporated herein by reference.

Another type of ink vehicle may be n-paraffinic, branched paraffinic, and/or aromatic hydrocarbons, typically with from about 5 to about 100, such as from about 20 to about 180 or from about 30 to about 60 carbon atoms, generally prepared by the refinement of naturally occurring hydrocarbons, such as BE SQUARE 185 and BE SQUARE 195, with molecular weights (Mn) of from about 100 to about 5,000, such as from about 250 to about 1,000 or from about 500 to about 800, for example such as available from Petrolite.

Highly branched hydrocarbons, typically prepared by olefin polymerization, such as the VYBAR materials available from Petrolite, including VYBAR 253 (Mn=520), VYBAR 5013 (Mn=420), and the like, may also be used. In addition, the ink vehicle may be an ethoxylated alcohol, such as available from Petrolite and of the general formula 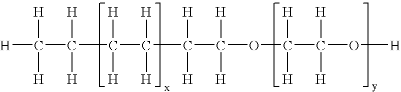
wherein x is an integer of from about 1 to about 50, such as from about 5 to about 40 or from about 11 to about 24 and y is an integer of from about 1 to about 70, such as from about 1 to about 50 or from about 1 to about 40. The materials may have a melting point of from about 60° C. to about 150° C., such as from about 70° C. to about 120° C. or from about 80° C. to about 110° C. and a molecular weight (Mn) range of from about 100 to about 5,000, such as from about 500 to about 3,000 or from about 500 to about 2,500. Commercial examples include UNITHOX 420 (Mn=560). UNITHOX 450 (Mn=900), UNITHOX 480 (Mn=2,250), UNITHOX 520 (Mn=700), UNITHOX 550 (Mn=1,100), UNITHOX 720 (Mn=875), UNITHOX 750 (Mn=1,400), and the like.

As an additional example, mention may be made of fatty amides, such as monoamides, tetra-amides, mixtures thereof, and the like, for example such as described in U.S. Pat. No. 6,858,070, incorporated herein by reference. Suitable monoamides may have a melting point of at least about 50° C., for example from about 50° C. to about 150° C., although the melting point can be below this temperature. Specific examples of suitable monoamides include, for example, primary monoamides and secondary monoamides. Stearamide, such as KEMAMIDE S available from Witco Chemical Company and CRODAMIDE S available from Croda, behenamide/arachidamide, such as KEMAMIDE B available from Witco and CRODAMIDE BR available from Croda, oleamide, such as KEMAMIDE U available from Witco and CRODAMIDE OR available from Croda, technical grade oleamide, such as KEMAMIDE O available from Witco, CRODAMIDE O available from Croda, and UNISLIP 1753 available from Uniqema, and erucamide such as KEMAMIDE E available from Witco and CRODAMIDE ER available from Croda, are some examples of suitable primary amides. Behenyl behenamide, such as KEMAMIDE EX666 available from Witco, stearyl stearamide, such as KEMAMIDE S-180 and KEMAMIDE EX-672 available from Witco, stearyl erucamide, such as KEMAMIDE E-180 available from Witco and CRODAMIDE 212 available from Croda, erucyl erucamide, such as KEMAMIDE E-221 available from Witco, oleyl palmitamide, such as KEMAMIDE P-181 available from Witco and CRODAMIDE 203 available from Croda, and erucyl stearamide, such as KEMAMIDE S-221 available from Witco, are some examples of suitable secondary amides. Additional suitable amide materials include KEMAMIDE W40 (N,N′-ethylenebisstearamide), KEMAMIDE P181 (oleyl palmitamide), KEMAMIDE W45 (N,N′-ethylenebisstearamide), and KEMAMIDE W20 (N,N′-ethylenebisoleamide).

High molecular weight linear alcohols, such as those available from Petrolite and of the general formula 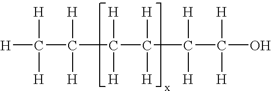
wherein x is an integer of from about 1 to about 50, such as from about 5 to about 35 or from about 11 to about 23, may also be used as the ink vehicle. These materials may have a melting point of from about 50° C. to about 150° C., such as from about 70° C. to about 120° C. or from about 75° C. to about 110° C., and a molecular weight (Mn) range of from about 100 to about 5,000, such as from about 200 to about 2,500 or from about 300 to about 1,500. Commercial examples include the UNILIN materials such as UNILIN 425 (Mn=460), UNILIN 550 (Mn=550), UNILIN 700 (Mn=700), and the like.

A still further example includes hydrocarbon-based waxes, such as the homopolymers of polyethylene available from Petrolite and of the general formula 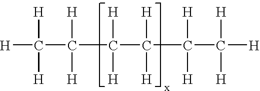
wherein x is an integer of from about 1 to about 200, such as from about 5 to about 150 or from about 12 to about 105. These materials may have a melting point of from about 60° C. to about 150° C., such as from about 70° C. to about 140° C. or from about 80° C. to about 130° C. and a molecular weight (Mn) of from about 100 to about 5,000, such as from about 200 to about 4,000 or from about 400 to about 3,000, Example waxes include the line of waxes, such as POLYWAX 500 (Mn=500), POLYWAX 655 (Mn=655), POLYWAX 850 (Mn=850), POLYWAX 1000 (Mn=1,000), and the like.

Another example includes modified maleic anhydride hydrocarbon adducts of polyolefins prepared by graft copolymerization, such as those available from Petrolite and of the general formulas 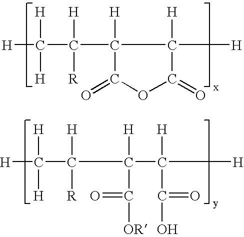
wherein R is an alkyl group with from about 1 to about 50, such as from about 5 to about 35 or from about 6 to about 28 carbon atoms, R′ is an ethyl group, a propyl group, an isopropyl group, a butyl group, an isobutyl group, or an alkyl group with from about 5 to about 500, such as from about 10 to about 300 or from about 20 to about 200 carbon atoms, x is an integer of from about 9 to about 13, and y is an integer of from about 1 to about 50, such as from about 5 to about 25 or from about 9 to about 13, and having melting points of from about 50° C. to about 150° C., such as from about 60° C. to about 120° C. or from about 70° C. to about 100° C.; those available from Petrolite and of the general formula 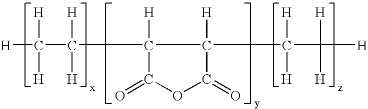
wherein x is an integer of from about 1 to about 50, such as from about 5 to about 25 or from about 9 to about 13, y is 1 or 2, and z is an integer of from about 1 to about 50, such as from about 5 to about 25 or from about 9 to about 13; and those available from Petrolite and of the general formula 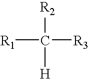
wherein R₁ and R₃ are hydrocarbon groups and R₂ is either of one of the general formulas 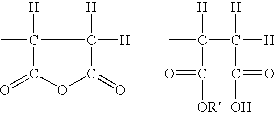
or a mixture thereof wherein R′ is an isopropyl group, which materials may have melting points of from about 70° C. to about 150° C., such as from about 80° C. to about 130° C. or from about 90° C. to about 125° C., with examples of modified maleic anhydride copolymers including CERAMER 67 (Mn=655, Mw/Mn=1.1), CERAMER 1608 (Mn=700, Mw/Mn=1.7), and the like.

Additional examples of suitable ink vehicles for the phase change inks include rosin esters, such as glyceryl abietate (KE-100); polyamides; dimer acid amides; fatty acid amides, including ARAMID C; epoxy resins, such as EPOTUF 37001, available from Riechold Chemical Company; fluid paraffin waxes; fluid microcrystalline waxes; Fischer-Tropsch waxes; polyvinyl alcohol resins; polyols; cellulose esters; cellulose ethers; polyvinyl pyridine resins; fatty acids; fatty acid esters; poly sulfonamides, including KETJENFLEX MH and KETJENFLEX MS80; benzoate esters, such as BENZOFLEX S552, available from Velsicol Chemical Company; phthalate plasticizers; citrate plasticizers; maleate plasticizers; polyvinyl pyrrolidinone copolymers; polyvinyl pyrrolidone/polyvinyl acetate copolymers; novolac resins, such as DUREZ 12 686, available from Occidental Chemical Company; and natural product waxes, such as beeswax, montan wax, candelilla wax, GILSONITE (American Gilsonite Company), and the like; mixtures of linear primary alcohols with linear long chain amides or fatty acid amides, such as those with from about 6 to about 24 carbon atoms, including PARICIN-9 (propylene glycol monohydroxystearate), PARICIN 13 (glycerol monohydroxystearate), PARICIN 15 (ethylene glycol monohydroxystearate), PARICIN 220 (N(2-hydroxyethyl)-12-hydroxystearamide), PARICIN 285 (N,N′-ethylene-bis-12-hydroxystearamide), FLEXRICIN 185 (N,N′-ethylene-bis-ricinoleamide), and the like. Further, linear long chain sulfones with from about 4 to about 16 carbon atoms, such as diphenyl sulfone, n-arnyl sulfone, n-propyl sulfone, n-pentyl sulfone, n-hexyl sulfone, n-heptyl sulfone, n-octyl sulfone, n-nonyl sulfone, n-decyl sulfone, n-undecyl sulfone, n-dodecyl sulfone, n-tridecyl sulfone, n-tetradecyl sulfone, n-pentadecyl sulfone, n-hexadecyl sulfone, chlorophenyl methyl sulfone, and the like, are suitable ink vehicle materials.

In addition, the ink vehicles described in U.S. Pat. No. 6,906,118, incorporated herein by reference in its entirety, may also be used. Also suitable as ink vehicles are liquid crystalline materials as disclosed in, for example, U.S. Pat. No. 5,122,187, the disclosure of which is totally incorporated herein by reference.

The ink vehicle may comprise one or more of the aforementioned suitable materials. As used herein, “one or more” and “at least one” refers to from 1 to about 10, such as from 1 to about 8 or from 1 to about 5 of any given feature disclosed herein.

The ink vehicle may comprise from about 25% to about 99.5% by weight of the ink, for example from about 30% to about 90% or from about 50% to about 85% by weight of the ink.

Many ink vehicles of phase change inks have an electrical conductivity of essentially zero. Thus, conductivity enhancing agents may be added to the ink vehicle in order to provide consistent conductivity to the ink. The conductivity is used as an input signal for a level sensor in the ink reservoir of the ink jet device.

Prior components of a phase change ink that may have contributed to the electrical conductivity if the phase change inks were colorants such as pigments and dyes, and dodecyl benzene sulfonic acid (DDBSA), as disclosed in U.S. Pat. No. 6,015,847, and incorporated herein by reference. However, utilization of these ingredients as conductivity enhancing agents is problematic.

Colorants give the ink a certain color (brightness, chroma and hue), which in turn is dependent on the dye concentration in the ink. Once the color gamut of a complete ink has been specified, any adjusting of the electrical conductivity by changing the colorant concentration in the ink may be very difficult, or simply impractical. Moreover, many colorants have a limited solubility in the nonpolar matrix mixture of an ink vehicle due to the appreciable dipole moments of their molecules. In other words, the concentration of the colorants in the ink vehicle cannot be increased in an unlimited way without risking phase separation in the liquid phase state. In addition, not all colorants increase electrical conductivity in an ink formulation to the same degree, and many do not affect conductivity at all. Thus, use of colorants to impart conductivity is not practical, and does not achieve inks with consistent and reliable conductivity.

DDBSA was originally applied as a proton-donating developer for magenta inks and has also been used in inks as an inexpensive and very strong conductivity-enhancing agent. Although it dissolves readily in phase change inks, it has many shortcomings. The shortcomings of DDBSA include: (1) DDBSA chemically attacks vital mechanical parts in the printheads at relatively low concentrations and thus considerably shortens printhead lifetime; (2) DDBSA is a liquid at ambient temperature, which may plasticize the ink formulation; (3) DDBSA affects the viscosity of the liquefied ink wider temperatures of operation, thus necessitating additional countermeasures during formulation; and (4) DDBSA has a limited lifetime at higher concentrations due to decay and degradation.

Thus, a suitable conductivity enhancing agent is still desired. In embodiments, the conductivity enhancing agent is an organic salt formed from an organic base and an acid. The conductivity enhancing agent does not detrimentally affect any printer parts (for example, printheads or reservoirs of an ink jet device) as do other conductivity enhancing agents (for example, DDBSA).

The organic base of the organic salt of the conductivity enhancing agent may be an organic amine and have at least one long hydrocarbon chain. “Long hydrocarbon chain” refers to, for example, a linear or branched carbon alkyl or aryl chain having from about 10 carbons to about 50 carbons, such as from about 15 to about 40 carbons or from about 15 carbons to about 30 carbons. The long carbon chain of the organic salt allows it to be miscible in the ink vehicle.

Examples of organic bases that are suitable for use herein are derived from tertiary amine compounds having the following generic formula, which may include tri-hexadecyl amine (ARMEEN® 316, molecular weight 689). 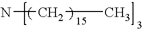
In embodiments the organic bases may be derived from trioctadecyl amine, tridodecyl amine, tritetradecyl amine, trieicosyl amine, tridocosylamine, tritetracosylamine, mixed forms like didodecyl octadecyl amine, didocosyl tetracosyl amine, ditetracosyl tetradecyl amine, and the like, and aryl-aliphatic compounds, such as di(1-decyl-4-nonyl-phenyl) docosyl amine: 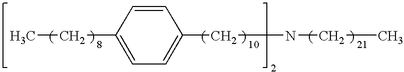
or 4-nonylphenyl dioctadecyl amine, as shown below:

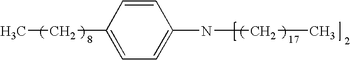

In embodiments, the organic base may be a primary, secondary or tertiary amine. An example of a suitable primary amine may be represented by the general formula 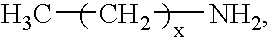
wherein x is an integer from about 1 to about 50, such as from about 10 to about 40 or from about 12 to about 30, for example, a hexadecyl amine. An example of a suitable secondary amine may be represented by the general formula 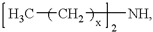
wherein x is an integer from about 1 to about 50, such as from about 10 to about 40 or from about 12 to about 30, for example, a di-octadecyl amine.

An acid reacts with the organic base described above to form the organic salt. Substituents in the acid anion with a high electronegativity, for example, fluorine atoms, are desirable in order to facilitate the reaction between acid and base and produce a large number of molecule anions and cations. These molecule anions and cations may act as carriers for the electrical charge in an applied outer electrical field. The substituents in the acid anion, when placed close enough to certain functional groups in the molecule, may pull electrons away from potentially acid O—H or C—H bonds. This allows for an easier separation of the positively charged hydrogen atoms (protons) from the remainder of the molecule. These mobile protons may then associate with the molecules of the base, and form molecular cations of this base. Thus, the presence of electronegative substituents in the molecules of the acid may tend to shift the equilibrium of neutral acids and bases towards charged species. In turn, these charged species may be the source for carriers having an electrical charge.

Another aspect is that the molecular ion of an acid suitable for use herein has a high mobility, thus enhancing the conductivity of the phase change ink. This high mobility may be achieved by using a small molecular ion. However, when small molecular ions are used, the solubility of the organic salt decreases. Thus, the size of the molecular ion must be sufficient to maintain the solubility of the organic salt in the phase change ink, while at the same time exhibiting sufficient mobility so as to enhance the conductivity of the phase change ink.

Examples of acid generated suitable molecular ions that may be used herein include the ions of acids such as trifluoroacetic acid, methane sulfonic acid and trifluoro methane sulfonic acid. Such acids may have a molecular weight from about 25 to about 250, such as from about 25 to about 225 or from about 50 to about 250.

The estimated half life of the organic salt under a constant temperature of about 120° C. is from about 15 days to about 250 days, such as from about 20 days to about 225 days or from about 20 days to about 200 days. This indicates that the conductivity-enhancing agent disclosed herein remains stable for an extended period of time. In comparison, DDBSA has a half life of approximately 3 days. Thus, the conductivity enhancing agents remain active and detectable by the conductivity sensors within the printer for a period of time, which typically exceeds the time period of operation.

The phase change ink disclosed herein may contain one organic salt, or a mixture of one or more suitable organic salts, for example from about 1 to about 10 organic salts, such as from about 1 to about 4 or from about 1 to about 2 organic salts. Each organic salt is present in the ink in any effective amount, for example from about 0.001 weight percent to about 8 weight percent, such as from about 0.1 weight percent to about 5 weight percent or from about 0.25 weight percent to about 5 weight percent of the ink.

The organic salt described herein imparts a high electrical conductivity to phase change inks by sufficiently dissociating into molecular ions with high ion mobility. Specifically, the organic salt will dissociate into ions, that is, anions and cations, to provide the phase change ink with high electrical conductivity during operation of an ink jet device.

The conductivity of the phase change ink having the conductivity enhancing agent therein may be from about 0.01 μS/cm to about 5 μS/cm, such as from about 0.05 μS/cm to about 4 μS/cm or from about 0.09 μS/cm to about 2.5 μS/cm. Conductivity may be measured by any known method, and herein is measured under melt conditions at about 120° C. by placing titanium electrodes in the molten ink and reading the resistivity output on a Rosemount Model 1054B LC Conductivity Meter at a frequency of 60 Hz. In general, the conductivity of a material can be measured in terms of the reciprocal of resistivity, which is a material specific and temperature dependent measurement for electrical resistance.

The organic salts disclosed herein are soluble in the nonpolar organic environment of phase change inks, demonstrate thermal stability in phase change inks when an ink jet device is operating, are waxy solids at room temperature, may positively influence the mechanical durability of printed, solid inks, and do not etch or attack printer parts which may contact the organic salts found in the phase change inks.

The phase change inks also contain at least one colorant, for example, from 1 to about 10, such as from 1 to about 4 or from 1 to about 2 colorants. The colorant is present in the ink in any desired amount, typically from about 0.5 to about 75 percent by weight of the ink vehicle or ink vehicle/propellant mixture, for example from about 1 to about 50 percent by weight of the ink vehicle or ink vehicle/propellant mixture.

Examples of suitable colorants include pigments, dyes, mixtures of pigments and dyes, mixtures of pigments, mixtures of dyes, and the like. Any dye or pigment may be chosen, provided that it is capable of being dispersed or dissolved in the ink vehicle and is compatible with the other ink components.

Examples of suitable pigments include, but are not limited to, Violet PALIOGEN Violet 5100 (BASF); PALIOGEN Violet 5890 (BASF); HELIOGEN Green L8730 (BASF); LITHOL Scarlet D3700 (BASF); SUNFAST® Blue 15:4 (Sun Chemical 249-0592); Hostaperm Blue B2G-D (Clariant); Permanent Red P F7RK; Hostaperm Violet BL (Clariant); LITHOL Scarlet 4440 (BASF); Bon Red C (Dominion Color Company); ORACET Pink RF (Ciba); PALIOGEN Red 3871 K (BASF); SUNFAST® Blue 15:3 (Sun Chemical 249-1284); PALIOGEN Red 3340 (BASF); SUNFAST® Carbazole Violet 23 (Sun Chemical 246-1670); LITHOL Fast Scarlet L4300 (BASF); Sunbrite Yellow 17 (Sun Chemical 275-0023); HELIOGEN Blue L6900, L7020 (BASF); Sunbrite Yellow 74 (Sun Chemical 272-0558); SPECTRA , PAC® C Orange 16 (Sun Chemical 276-3016); HELIOGEN Blue K6902, K6910 (BASF); SUNFAST® Magenta 122 (Sun Chemical 228-0013); HELIOGEN Blue D6840, D7080 (BASF); Sudan Blue OS (BASF); NEOPEN Blue FF4012 (BASF); PV Fast Blue B2GO1) (Clariant); IRGALITE Blue BCA (Ciba); PALIOGEN Blue 6470 (BASF); Sudan Orange G (Aldrich), Sudan Orange 220 (BASF); PALIOGEN Orange 3040 (BASF); PALIOGEN Yellow 152, 1560 (BASF); LITHOL Fast Yellow 0991 K (BASF); PALIOTOl, Yellow 1840 (BASF); NOVOPERM Yellow FGL (Clariant); Lumogen Yellow D0790 (BASF); Suco-Yellow L1250 (BASF); Suco-Yellow D1355 (BASF); Suco Fast Yellow D1 355, D1 351 (BASF); HOSTAPERM Pink E 02 (Clariant); Hansa Brilliant Yellow 5GX03 (Clariant); Permanent Yellow GRL, 02 (Clariant); Permanent Rubine L6B 05 (Clariant); FANAL Pink D4830 (BASF); CINQUASIA Magenta (DU PONT), PALIOGEN Black L0084 (BASF); Pigment Black K801 (BASF); and carbon blacks such as REGAL 330™ (Cabot), Carbon Black 5250, Carbon Black 5750 (Columbia Chemical), mixtures thereof and the like.

Examples of suitable dyes include Usharect Blue 86 (Direct Blue 86), available from Ushanti Color; Intralite Turquoise 8GL (Direct Blue 86), available from Classic Dyestuffs; Chemictive Brilliant Red 7BH (Reactive Red 4), available from (Chemiequip; Levafix Black EB, available from Bayer; Reactron Red H8B (Reactive Red 31), available from Atlas Dye-Chem; D&C Red #28 (Acid Red 92), available from Warner-Jenkinson; Direct Brilliant Pink B, available from Global Colors; Acid Tartrazine available from Metrochem Industries; Cartasol Yellow 6GF Clariant; Carta Blue 2GL, available from Clariant; and the like.

In embodiments, solvent dyes may be utilized. Examples of solvent dyes include spirit soluble dyes which are compatible with the ink vehicles disclosed herein. Examples of suitable spirit solvent dyes include Neozapon Red 492 (BASE); Orasol Red G (Ciba); Direct Brilliant Pink B (Global Colors); Aizen Spilon Red C-BH (Hodogaya Chemical); Kayanol Red 3BL (Nippon Kayaku); Spirit Fast Yellow 3G; Aizen Spilon Yellow C-GNH (Hodogaya Chemical); Cartasol Brilliant Yellow 4GF (Clariant); Pergasol Yellow CGP (Ciba); Orasol Black RLP (Ciba); Savinyl Black RLS (Clariant); Morfast Black Conc. A (Rohm and Haas); Orasol Blue GN (Ciba); Savinyl Blue GLS (Sandoz); Luxol Fast Blue MBSN (Pylam); Sevron Blue 5GMF (Classic Dyestuffs); Basacid Blue 750 (BASF), Neozapon Black X51 [C.I. Solvent Black, C.I. 12195] (BASF), Sudan Blue 670 [C.I. 61554] (BASF), Sudan Yellow 146 [C.I. 12700] (BASF), Sudan Red 462 [C.I. 260501] (BASF) and the like.

In embodiments, suitable colorants, dyes and/or pigments may be selected from those disclosed in U.S. Pat. No. 6,726,755, U.S. Pat. No. 6,472,523, U.S. Pat. No. 6,476,219, U.S. Pat. No. 6,673,139, U.S. Pat. No. 6,713,614, U.S. Pat. No. 6,755,902, U.S. Pat. No. 6,576,747, U.S. Pat. No. 6,576,748, U.S. Pat. No. 6,590,082, U.S. Pat. No. 6,646,111, U.S. Pat. No. 6,663,703, U.S. Pat. No. 6,860,931, U.S. Pat. No. 6,835,238, U.S. Pat. No. 6,958,406 and U.S. Pat. No. 6,821,327, each of which is incorporated herein by reference.

Optionally, a propellant may be contained in the phase change ink. Suitable propellants for the phase change ink, present in any effective amount such as from about 10 to about 90 percent by weight, for example from about 20 to about 50 percent by weight, of the ink generally have melting points of from about 50° C. to about 150° C., for example from about 80° C. to about 120° C. In another embodiment, the propellants generally have a boiling point of from about 180° C. to about 250° C., for example from about 200° C. to about 230° C. Further, the surface tension of the propellant in its liquid state at the operating temperature of the ink may be from about 20 to about 65 dynes per centimeter, for example from about 40 to about 65 dynes per centimeter, to enhance refill rates, paper wetting, and color mixing. In addition, the propellants ideally have a viscosity at the operating temperature of the ink of from about 1 to about 20 cP, for example from about 1 to about 15 cP, to enhance refill, jettability, and substrate penetration. The propellant may also be thermally stable in its molten state so that it does not undergo decomposition to yield gaseous products or to form heater deposits.

Examples of suitable propellants for the phase change inks include, for example, water; hydrazine; alcohols, such as ethanol, propanol, butanol, 2,5-dimethyl-2,5-hexanediol, 3-hydroxy benzyl alcohol, and the like; cyclic amines and ureas, including 1,3-dimethyl urea, such as imidazole, substituted imidazoles, including 2-imidazolidone, 2-ethyl imidazole, 1,2,4-triazole, and the like; pyrazole and substituted pyrazoles, including 3,5-dimethyl pyrazole and the like; pyrazine; carboxylic acids; sulfonic acids; aldehydes and ketones; hydrocarbons, such as biphenyl, hexane, benzene; esters; phenols, including phenol, dichlorophenol, other halogen substituted phenols, and cresols; amides, such as propionamide, lactamide, and the like; imides; halocarbons; urethanes; ethers; sulfones, including dimethyl sulfone, methyl sulfone, diethyl sulfone, and diphenyl sulfone; sulfamides, such as methyl sulfamide; sulfonamides, such as ortho, para-toluenesulfonamide, methyl sulfonamide, and the like; phosphites; phosphonates; phosphates; alkyl sulfides, such as methyl sulfide; alkyl acetates, such as methyl acetate; sulfur dioxide; alkylene carbonates, such as propylene carbonate; succinimide; and the like. Sulfones, such as dimethyl sulfone, diethyl sulfone, diphenyl sulfone, and the like, and any mixtures thereof, may also be used.

The ink of embodiments may further include conventional additives to take advantage of the known functionality associated with such conventional additives. Such additives may include, for example, biocides, defoamers, slip and leveling agents, plasticizers, pigment dispersants, viscosity modifiers, antioxidants, absorbers, etc.

Optional biocides may be present in amounts of from about 0.1 to about 1.0 percent by weight of the ink. Suitable biocides include, for example, sorbic acid, 1-(3-chloroallyl)-3,5,7-triaza-1-azoniaadamantane chloride, commercially available as DOWICIL, 200 (Dow Chemical Company), vinylene-bis thiocyanate, commercially available as CYTOX 3711 (American Cyanamid Company) disodium ethylenebis-dithiocarbamate, commercially available as DITHONE D14 (Rohm & Haas Company), bis(trichloromethyl)sulfone, commercially available as BIOCIDE N-1386 (Stauffer Chemical Company), zinc pyridinethione, commercially available as zinc omadine (Olin Corporation), 2-bromo-t-nitropropane-1,3-diol, commercially available as ONYXIDE 500 (Onyx Chemical Company), BOSQUAT MB50 (Louza, Inc.), and the like. In addition, other optional additives such as dispersing agents or surfactants may be present in the inks, typically in amounts of from about 0.01 to about 20 percent by weight. Plasticizers that may be used include pentaerythritol tetrabenzoate, commercially available as BENZOFLEX S552 (Velsicol Chemical Corporation), trimethyl titrate, commercially available as CITROFLEX 1 (Monflex Chemical Company), N,N-dimethyl oleamide, commercially available as SANTICIZER M-18-OL (C.P. Hall Company), a benzyl phthalate, commercially available as SANTICIZER 278 (Ferro Corporation), and the like, may be added to the ink vehicle, and may constitute from about 1 to 100 percent of the ink vehicle component of the ink. Plasticizers can either function as the ink vehicle or can act as an agent to provide compatibility between the ink propellant, which generally is polar, and the ink vehicle, which generally is non-polar.

The viscosity modifier may be (1) 2-hydroxybenzyl alcohol, (2) 4-hydroxybenzyl alcohol, (3) 4-nitrobenzyl alcohol, (4) 4-hydroxy-3-methoxy benzyl alcohol, (5) 3-methoxy-4-nitrobenzyl alcohol, (6) 2-amino-5-chlorobenzyl alcohol, (7) 2-amino-5-methylbenzyl alcohol, (8) 3-amino-2-methylbenzyl alcohol, (9) 3-amino-4-methyl benzyl alcohol, (10) 2(2-(aminomethyl phenylthio) benzyl alcohol, (11) 2,4,6-trimethylbenzyl alcohol, (12) 2-amino-2-methyl-1,3-propanediol, (13) 2-amino-1-phenyl-1,3-propanediol, (14) 2,2-dimethyl-1-phenyl-1,3-propanediol, (15) 2-bromo-2-nitro-1,3-propanediol, (16) 3-tert-butylamino-1,2-propanediol, (17) 1,1-diphenyl-1,2-propanediol, (18) 1,4-dibromo-2,3-butanediol, (19) 2,3-dibromo-1,4-butanediol, (20) 2,3-dibromo-2-butene-1,4-diol, (21) 1,1,2-triphenyl-1,2-ethanediol, (22) 2-naphthalenemethanol, (23) 2-methoxy-1-naphthalenemethanol, (24) decafluoro benzhlydrol, (25) 2-methylbenzhydrol, (26) 1-benzeneethanol, (27) 4,4′-isopropylidene bis(2-(2,6-dibromo phenoxy)ethanol), (28) 2,2′-(1,4-phenylenedioxy)diethanol, (29) 2,2-bis(hydroxymethyl)-2,2′,2″-nitrilotriethanol, (30) di(trimethylolpropane), (31) 2-amino-3-phenyl-1-propanol, (32) tricyclohexylmethanol, (33) tris(hydroxymethyl) aminomethane succinate, (34) 4,4′-trimethylene bis(1-piperidine ethanol), (35) N-methyl glucamine, (36) xylitol, or mixtures thereof. When present, the viscosity modifier is present in the ink in any effective amount, such as from about 30 percent to about 55 percent by weight of the ink or from about 35 percent to about 50 percent by weight of the ink.

Optional antioxidants in the ink may protect the images from oxidation and also may protect the ink components from oxidation while existing as a heated melt in the ink reservoir. Examples of suitable antioxidants include (1) N,N′-hexamethylene bis(3,5-di-tert-butyl-4-hydroxy hydrocinnamamide) (IRGANOX 1098, available from Ciba-Geigy Corporation), (2) 2,2-bis(4-(2-(3,5-di-tert-butyl-4-hydroxyhydrocinnamoyloxy))ethoxyphenyl) propane (TOPANOL-205, available from ICI America Corporation), (3) tris(4-tert-butyl-3-hydroxy-2,6-dimethyl benzyl) isocyanurate (CYANOX 1790, 41,322-4, LTDP, Aldrich D12,840-6), (4) 2,2′-ethylidene bis(4,6-di-tert-butylphenyl) fluoro phosphonite (ETHANOX-398, available from Ethyl Corporation), (5) tetrakis(2,4-di-tert-butylphenyl-4,4′-biphenyl diphosphonite (ALDRICH 46,852-5; hardness value 90), (6) pentaerythritol tetrastearate (TCI America P0739), (7) tributylammonium hypophosphite (Aldrich 42,009-3), (8) 2,6-di-tert-butyl-4-methoxyphenol (Aldrich 25,106-2), (9) 2,4-di-tert-butyl-6-(4-methoxybenzyl) phenol (Aldrich 23,008-1), (10) 4-bromo-2,6-dimethylphenol (Aldrich 34,951-8), (11) 4-bromo-3,5-didimethylphenol (Aldrich B6,420-2), (12) 4-bromo-2-nitrophenol (Aldrich 30,987-7), (13) 4-(diethyl aminomethyl)-2,5-dimethylphenol (Aldrich 14,668-4), (14) 3-dimethylaminophenol (Aldrich D14,400-2), (15) 2-amino-4-tert-amylphenol (Aldrich 41,258-9), (16) 2,6-bis(hydroxymethyl)-p-cresol (Aldrich 22,752-8), (17) 2,2′-methylenediphenol (Aldrich B4,680-8), (18) 5-(diethylamino)-2-nitrosophenol (Aldrich 26,951-4), (19) 2,6-dichloro-4-fluorophenol (Aldrich 28,435-1), (20) 2,6-dibromo fluoro phenol (Aldrich 26,003-7), (21) α-trifluoro-o-creso-1 (Aldrich 21,979-7), (22) 2-bromo-4-fluorophenol (Aldrich 30,246-5), (23) 4-fluorophenol (Aldrich F1,320-7), (24) 4-chlorophenyl-2-chloro-1,1,2-tri-fluoroethyl sulfone (Aldrich 13,823-1), (25) 3,4-difluoro Phenylacetic acid (Aldrich 29,043-2), (26) 3-fluorophenylacetic acid (Aldrich 24,804-5), (27) 3,5-difluoro phenylacetic acid (Aldrich 29,044-0), (28) 2-fluorophenylacetic acid (Aldrich 20,894-9), (29) 2,5-bis (trifluoromethyl) benzoic acid (Aldrich 32,527-9), (30) ethyl-2-(4-(4-(trifluoromethyl) Phenoxy) Phenoxy) propionate (Aldrich 25,074-0), (31) tetrakis(2,4-di-tert-butyl phenyl) 4,4′-biphenyl diphosphonite (Aldrich 46,852-5), (32) 4-tert-amyl phenol (Aldrich 15,384-2), (33) 3-(2H-benzotriazol-2-yl)-4-hydroxy phenethylalcohol (Aldrich 43,071-4), NAUGARD 76, NAUGARD 445, NAUGARD 512, AND NAUGARD 524 (manufactured by Uniroyal Chemical Company), and the like, as well as mixtures thereof. The antioxidant, when present, may be present in the ink in any desired or effective amount, such as from about 0.25 percent to about 10 percent by weight of the ink or from about 1 percent to about 5 percent by weight of the ink.

The ink can also optionally contain a UV absorber. The optional UV absorbers primarily protect the generated images from UV degradation. Specific examples of suitable UV absorbers include (1) 2-bromo-2′,4-dimethoxyacetophenone (Aldrich 19,948-6), (2) 2-bromo-2′,5′-dimethoxyacetophenone (Aldrich 10,458-2), (3) 2-bromo-3′-nitroacetophenone (Aldrich 34,421-4), (4) 2-bromo-4′-nitroacetophenone (Aldrich 24,561-5), (5) 3′,5′-diacetoxyacetophenone (Aldrich 11,738-2), (6) 2-phenylsulfonyl acetophenone (Aldrich 34,150-3), (7) 3′-aminoacetophenone (Aldrich 13,935-1), (8) 4′-aminoacetophenone (Aldrich A3,800-2), (9) 1H-benzotriazole-1-acetonitrile (Aldrich 46,752-9), (10) 2-(2H-benzotriazol-2-yl)-4,6-di-tert-pentylphenol (Aldrich 42,274-6), (11) 1,1-(1,2-ethane-diyl)bis(3,3, 5,5-tetramethylpiperazinone) (commercially available from Goodrich Chemicals), (12) 2,2,4-trimethyl-1,2-hydroquinoline (commercially available from Mobay Chemical), (13) 2-(4-benzoyl-3-hydroxy phenoxy)ethylacrylate, (14) 2-dodecyl-N-(1,2,2,6,6-pentamethyl-4-piperidinyl) succinimide (commercially available from Aldrich Chemical Co., Milwaukee, Wis.), (15) 2,2,6,6-tetramethyl-4-piperidinyl/β-tetramethyl-3,9-(2,4,8,10-tetraoxo spiro(5,5)-undecane) diethyl-1,2,3,4-butane tetracarboxylate (commercially available from Fairmount), (16) N-(p-ethoxycarbonylphenyl)-N′-ethyl-N′-phenylformadine (commercially available from Givaudan), (17) 6-ethoxy-1,2-dihydro-2,2,4-trimethylquinoline (commercially available from Monsanto Chemicals), (18) 2,4,6-tris-(N-1,4-dimethylpentyl-4-phenylenediamino)-1,3,5-triazine (commercially available from Uniroyal), (19) 2-dodecyl-N-(2,2,6,6-tetrame-thyl-4-piperidinyl) succinimide (commercially available from Aldrich Chemical Co.), (20) N-(1-acetyl-2,2,6,6-tetramethyl-4-piperidinyl)-2-dodecyl succinimide (commercially available from Aldrich Chemical Co.), (21) (1,2,2,6,6-pentamethyl-4-piperidinyl/β-tetramethyl-3,9-(2,4,8,10-tetra oxo-spiro-(5,5)undecane)diethyl)-1,2,3,4-butane tetracarboxylate (commercially available from Fairmount), (22) (2,2,6,6-tetramethyl-4-piperidinyl)-1,2,3,4-butane tetracarboxylate (commercially available from Fairmount), (23) nickel dibutyl dithio carbamate (commercially available as UV-Chek AM-105 from Ferro), (24) 2-amino-2′,5-dichlorobenzophenone (Aldrich 10,515-5), (25) 2′-amino-4′,5′-dimethoxyacetophenone (Aldrich 32,922-3), (26) 2-benzyl-2-(dimethylamino)-4′-morpholino butyrophenone (Aldrich 40,564-7), (27) 4′-benzyloxy-2′-hydroxy-3′-methylacetophenone (Aldrich 29,884-0), (28) 4,4′-bis(diethylamino) benzophenone (Aldrich 16,032-6), (29) 5-chloro-2-hydroxy benzophenone (Aldrich C4,470-2), (30) 4′-piperazinoacetophenone (Aldrich 13,646-8), (31) 4′-piperidinoacetophenone (Aldrich 11,972-5), (32) 2-amino-5-chlorobenzophenone (Aldrich A4,556-4), (33) 3,6-bis(2-methyl-2-morpholinopropionyl)-9-octylcarbazole (Aldrich 46,073-7), and the like, as well as mixtures thereof. When present, the optional UV absorber may be present in the ink, in any desired or effective amount, such as from about 1 percent to about 10 percent by weight of the ink or from about 3 percent to about 5 percent by weight of the ink.

The phase change ink compositions may be prepared by combining all of the ingredients (the organic base and the acid being considered individual ingredients), heating the mixture to at least its melting point, for example from about 50° C. to about 120° C., and stirring the mixture, for example from about 5 seconds to about 10 minutes or more, to obtain a substantially homogeneous, uniform melt. When pigments are the selected colorants, the molten mixture may be subjected to grinding in an attritor or ball mill apparatus to effect dispersion of the pigment in the ink vehicle. Once formed, the ink may be cooled to room temperature, for example, from about 23° C. to about 27° C., wherein it is ready for addition into an ink jet device.

As an alternative, the phase change inks disclosed herein may be prepared by first generating the organic salt. First, the organic base is melted at a temperature of from about 80° C. to about 160° C. such as from about 85° C. to about 150° C. or from about 90° C. to about 140° C. Once the organic base has melted, the organic base may be stirred, and the acid is added. The molten combination of organic base and acid is comprised of from about 60 weight percent to about 95 weight percent organic base, such as from about 63 weight percent to about 95 weight percent or from about 68 weight percent to about 95 weight percent of organic base in the molten combination. The remaining portion of the molten combination is comprised of the acid. The cation of the organic base reacts with the anion of the acid forming the organic salt disclosed herein. The melt is maintained from about 5 minutes to about 2 hours, such as from about 10 minutes to about 1.5 hours or from about 15 minutes to about 1 hour. The molten organic salt formed is allowed to cool and harden. The organic salt may then be added to a molten ink vehicle.

Printed images may be generated with the ink described herein by incorporating the ink into an ink jet device, for example a thermal ink jet device, an acoustic ink jet device or a piezoelectric ink jet device, and concurrently causing droplets of the molten ink to be ejected in a pattern onto a substrate such as paper or transparency material, which can be recognized as an image. The ink is typically included in the at least one reservoir connected by any suitable feeding device to the ejecting channels and orifices of the ink jet head for ejecting the ink. In the jetting procedure, the ink jet head may be heated, by any suitable method, to the jetting temperature of the inks. The phase change inks are thus transformed from the solid state to a molten state for jetting. “At least one” or “one or more” as used to describe components of the ink jet device, such as the ejecting channels, orifices, etc., refers to from 1 to about 2 million, such as from about 1000 to about 1.5 million or about 10,000 to about 1 million of any such component found in the ink jet device. “At least one” or “one or more” as used to describe other components of the ink jet device such as the ink jet head, reservoir, feeder, etc., refers to from 1 to about 15, such as from 1 to about 8 or from 1 to about 4 of any such component found in the ink jet device.

The inks can also be employed in indirect (offset) printing ink jet applications, wherein when droplets of the melted ink are ejected in an imagewise pattern onto a recording substrate, the recording substrate is an intermediate transfer member and the ink in the imagewise pattern is subsequently transferred from the intermediate transfer member to a final recording substrate, such as paper or transparency.

The phase change ink having the conductivity enhancing agent disclosed herein may be utilized in any ink jet device, and are particularly suitable for use in devices that measure ink conductivity in the reservoirs in determining an amount of ink remaining in the at least one reservoir. Without limiting the disclosure herein, it is theorized that the ink reservoirs for each of the colors, such as black, cyan, magenta, and yellow, are each individually equipped with sensors having metal electrodes. Within the printer, these electrodes are connected to a monitoring facility which measures conductance, and hence conductivity, by applying a voltage to the electrodes. The measured conductance is then compared to a number, which is stored in the memory of the processor unit of the printer. If the difference between a measured value and a stored value of conductance becomes less than a threshold value, a signal is sent to the heater unit of the ink jet device, which will melt solid ink into the reservoir, until the difference is minimized or becomes zero.

To summarize, when the conductivity readings are considered to be statistically distributed over time, all average value that may be constant over time and a variation derived by standard deviation is obtained. The average value of conductivity (and a desirable narrow range of variation) enables the sensor(s) in the ink reservoir to distinguish between “full” and “empty” states. If “empty” is measured in the reservoir, additional ink may be liquefied and supplied to the “empty” reservoir. The additives disclosed herein provide stable conductivity readings over time, while inert toward ink components and ink jet device parts.

Embodiments described above will now be further illustrated by way of the following examples.

1. Synthesis and Characterization of the Ink Conductivity Enhancers

### EXAMPLE 1

Synthesis of Tri-Hexadecyl Ammonium-Trifluoro Acetate

About 100 grams of pre-melted ARMEEN 316 (MW=689) was added to a 236.56 mL flask with a magnetic stir bar. The flask was placed in a 100° C. oil bath and stirring was begun. About 16.5 g of trifluoroacetic acid (MW=114) was carefully added. Vigorous bubbling was observed. After stirring for about a half-hour, the contents were poured into an aluminum mold and allowed to solidify.

### EXAMPLE 2

Synthesis of Tri-Hexadecyl 4 Ammonium-Methyl Sulfonate

About 50 grams of pre-melted ARMEEN 316 (MW=689) was added to a 118.28 mL flask with a magnetic stir bar. The flask was placed in a 100° C. oil bath and stirring was begun. About 7.0 g of methane sulfonic acid (MW=96) was carefully added. Vigorous bubbling was observed. After stirring for about a half-hour, the contents were poured into an aluminum mold and allowed to solidify.

### EXAMPLE 3

Synthesis of Tri-Hexadecyl Ammonium-Trifluoromethyl Sulfonate

About 47 grams of pre-melted ARMEEN 316 (MW=689) was added to a 118.28 mL flask with a magnetic stir bar. The flask was placed in a 100° C. oil bath and stirring was begun. About 10.0 g of trifluoro methane sulfonic acid (MW=150) was carefully added. Vigorous bubbling was observed. After stirring for about a half-hour, the contents were poured into an aluminum mold and allowed to solidity.

2. Performance Characterization of the Ink Conductivity Enhancers

2.1 Preparation of Mixtures with Hot-Melt Ink Base and Inks

### EXAMPLE 4

Preparation for Conductivity Scans

397 grams of a POLYWAX® based phase change ink carrier (“Ink Carrier”) was heated in an oven at a temperature of about 135° C. until molten, for a total time of approximately 2.5 hours. After this time, the liquid ink base was poured into a warm (for example, about 120° C.) metal beaker. The beaker was then positioned in a 120° C. pre-heated heating mantle, and stirring of the liquid base was immediately started. After ten minutes, thermal equilibrium was reached, and the conductivity meter probe was inserted into the ink melt. By inserting the conductivity meter probe into the ink melt, the temperature dropped to below 120° C. After an additional waiting time of approximately 30 minutes, thermal equilibrium was regained, and a baseline conductivity value of 0.0023 μS/cm was measured.

Subsequently, increasing amounts of tri-hexadecyl ammonium-trifluoromethyl sulfonate were added to the ink melt, and conductivity measurements were performed.

The same steps were performed to prepare conductivity measurements with tri-hexadecyl ammonium-methyl sulfonate (blended into 397 grams of the Ink Carrier, ink base conductivity of 0.0021 μS/cm), tri-hexadecyl ammonium-trifluoro acetate (blended into 336.5 grams of the phase change ink carrier, ink base conductivity of 0.0022 μS/cm), and DDBSA (used as a reference, blended into 402 grams of the Ink Carrier, ink base conductivity of 0.0025 uS/cm).

Preparation for Study of Impact on Viscosity and Mechanical Properties of the Ink Carrier

Five batches of 400 grams each of an Ink Carrier were heated in an oven until molten, for a total time of approximately 2.5 hours. Subsequently, each liquid ink base was poured into an individual warm (for example, about 120° C.) metal beaker. Each beaker was then positioned in a 120° C. preheated heating mantle, and the liquid base was immediately stirred. After thermal equilibrium was achieved, varying amounts of tri-hexadecyl ammonium-trifluoro acetate were added:

(1) 1 gram, translating into a 0.25 wt % solution of trifluoro acetate in the Ink Carrier,

(2) 3.02 grams, translating into a 0.75 wt % solution of trifluoro acetate in the Ink Carrier,

(3) 5.06 grains, translating into a 1.25 wt % solution of trifluoro acetate in the Ink Carrier,

(4) 10.26 grams, translating into a 2.5 wt % solution of trifluoro acetate in the Ink Carrier, and

(5) 21.05 grams, translating into a 5.0 wt % solution of trifluoro acetate in the Ink Carrier.

The solutions were stirred for approximately another 45 minutes, and then poured into aluminum pans for solidification.

### EXAMPLE 6

Preparation for Study of Impact on Viscosity and Mechanical Properties of Magenta Ink

409.5 grams of a magenta POLYWAX® based phase change ink (“Magenta Ink”) were heated in an oven set to about 135° C. until molten, for a total time of approximately 2 hours. After this period, the ink was poured into a warm (for example, about 120° C.) metal beaker. The beaker was then placed in a 120° C. preheated heating mantle, and the liquid ink was stirred immediately. After about 25 minutes, thermal equilibrium was reached, and 21.55 grams of tri-hexadecyl ammonium-trifluoro acetate was added. This 5 weight percent solution of trifluoro acetate in magenta ink was then stirred at 120° C. for another hour, before pouring it into aluminum pans for solidification.

This procedure was repeated two more times with (1) 414.75 grams of magenta ink and 21.83 grams of tri-hexadecyl ammonium-methyl sulfonate, and (2) 417.65 grams of magenta ink and 21.95 grams of tri-hexadecyl ammonium-trifluoromethyl sulfonate, thus producing solutions of 5 weight percent of the respective salts in magenta ink.

2.2 Measurement of Concentration Dependence of Conductivity

### EXAMPLE 7

Measurements of Electrical Conductivity on a DDBSA Blend with Ink Carrier for Reference Purposes

While being stirred at 120° C., prescribed amounts of DDBSA were added in several steps to 402 grams of a phase change ink carrier, which was prepared as described above in Example 4. After a waiting for approximately 30 minutes, the electrical conductivity was determined, and another portion of DDBSA was added. The amounts of DDBSA added, the concentration of DDBSA, and conductivity readings are summarized in Table 1 below.

TABLE 1

| Grams DDBSA Added | Weight Percent DDBSA | Conductivity, μS/cm |
|---|---|---|
| 0.00 | 0.00 | 0.0025 |
| 0.56 | 0.14 | 0.16 |
| 1.36 | 0.47 | 0.27 |
| 1.08 | 0.74 | 0.46 |

### EXAMPLE 8

Measurements of Electrical Conductivity on Ink Carrier Tri-Hexadecyl Ammonium-trifluoromethyl Sulfonate Mixtures

While stirring at 120° C., prescribed amounts of tri-hexadecyl ammonium-trifluoromethyl sulfonate were added in several steps to 397 grams of Ink Carrier, which had been prepared as described in Example 4. After a waiting time of approximately 30 minutes, the electrical conductivity was determined using a Rosemount Model 1054B LC Conductivity Meter at a frequency of 60 Hz, and another portion of tri-hexadecyl ammonium-trifluoromethyl sulfonate was added. Amounts of tri-hexadecyl ammonium-trifluoromethyl sulfonate added, the concentration of tri-hexadecyl ammonium-trifluoromethyl sulfonate, and the conductivity readings are summarized below in Table 2.

TABLE 2

| | Weight Percent | |
|---|---|---|
| Grams Tri-Hexadecyl | Tri-Hexadecyl | |
| Ammonium- | Ammonium- | |
| Trifluoromethyl | Trifluoromethyl | Conductivity, |
| Sulfonate Added | Sulfonate | μS/cm |
| 0.00 | 0.00 | 0.0021 |
| 4.01 | 1.00 | 0.26 |
| 4.20 | 2.03 | 0.62 |
| 4.11 | 3.01 | 1.10 |

This same procedure was repeated for tri-hexadecyl ammonium-trifluoro acetate, and tri-hexadecyl ammonium-methyl sulfonate. The results are summarized in Tables 3 and 4 below.

TABLE 3

| | Weight Percent | |
|---|---|---|
| Grams Tri-Hexadecyl | Tri-Hexadecyl | |
| Ammonium-Trifluoro | Ammonium-Trifluoro | Conductivity, |
| Acetate Added | Acetate | μS/cm |
| 0.00 | 0.00 | 0.0023 |
| 3.31 | 0.97 | 0.054 |
| 3.39 | 1.95 | 0.10 |
| 3.39 | 2.91 | 0.15 |

TABLE 4

| | Weight Percent | |
|---|---|---|
| Grams Tri-Hexadecyl | Tri-Hexadecyl | |
| Ammonium-Methyl | Ammonium-Methyl | Conductivity, |
| Sulfonate Added | Sulfonate | μS/cm |
| 0.00 | 0.00 | 0.0021 |
| 4.09 | 1.02 | 0.11 |
| 4.08 | 2.01 | 0.23 |
| 4.10 | 3.00 | 0.38 |

2.3. Stability of Conductivity Over a Longer Period

### EXAMPLE 9

Measurements of Electrical Conductivity Over a 6-Day Period on a DDBSA Blend with Ink Carrier as a Control

Following the procedure outlined in Example 4, a solution of DDBSA in an Ink Carrier was made, which had an initial conductivity of 1.52 μS/cm at 120° C. This solution was kept at a temperature of about 120° C. and stirred for approximately 6 days, while its electrical conductivity was measured in irregular time intervals.

The electrical conductivity decreased over time for such an over-concentrated solution. The kinetic model had a time constant of about 0.24 d⁻¹ for the best fit, and the half-life time was determined to be approximately 2.7 days.

### EXAMPLE 10

Measurements of Electrical Conductivity Over a 6-Day Period on a Blend of Tri-hexadecyl Ammonium-trifluoromethyl Sulfonate with Ink Carrier

Following the procedure outlined in Example 4, a solution of tri-hexadecyl ammonium-trifluoromethyl sulfonate in an Ink Carrier was made, which had an initial conductivity of about 1.08 μS/cm at temperature of about 120° C. This solution was kept at a temperature of about 120° C. and stirred for approximately 5 days, while its electrical conductivity was measured in irregular time intervals.

The kinetic model had a time constant of about 0.011 d⁻¹ for the first-order fit, and the half-life time was determined to be about 63 days.

### EXAMPLE 11

Measurements of Electrical Conductivity Over an Approximate 6-Day Period on a Blend of Tri-hexadecyl Ammonium-methyl Sulfonate with Ink Carrier

Following the procedure outlined in Example 4, a solution of tri-hexadecyl ammonium-methyl sulfonate in an Ink Carrier was made, which had an initial conductivity of about 0.38 μS/cm at about 120° C. This solution was kept at a temperature of about 120° C. for almost 6 days, while its electrical conductivity was measured in irregular time intervals.

The kinetic model had a time constant of about 0.0048 d⁻¹ for the first-order fit, and the half-life time was determined to be about 143 days.

We performed similar tests as described in Examples 9, 10 and 11, for tri-hexadecyl ammonium-trifluoro acetate. Based on the results, simple kinetic models for the conductivity drop-off were calculated. The model parameters are summarized below in Table 5.

TABLE 5

| | Concen- | | | | |
|---|---|---|---|---|---|
| | tration | Initial | | | |
| | in Ink | Conduc- | Order | Rate | Half-life |
| Name of | Carrier, | tivity, | of | Constant, | Period, |
| Electrolyte | wt % | μS/cm | Model | Day⁻¹ | Days |
| DDBSA | 3.80 | 1.520 | 2.3 | 0.241 | 2.71 |
| Tri-Hexadecyl | 2.91 | 0.153 | 5.7 | 1692 | 20.3 |
| Ammonium- | | | | | |
| Trifluoro | | | | | |
| Acetate | | | | | |
| Tri-Hexadecyl | 3.00 | 0.383 | 1.0 | 0.005 | 143 |
| Ammonium- | | | | | |
| Methyl | | | | | |
| Sulfonate | | | | | |
| Tri-Hexadecyl | 3.01 | 1.081 | 1.0 | 0.011 | 63 |
| Ammonium- | | | | | |
| Trifluoromethyl | | | | | |
| Sulfonate | | | | | |

The data from Table 5 suggest a higher stability of conductivity readings for solutions of tri-hexadecyl ammonium-methyl sulfonate and tri-hexadecyl ammonium-trifluoromethyl sulfonate, when compared to a solution of DDBSA in the Ink Carrier.

2.4 Impact of Conductivity Enhancers on other Ink Properties

One purpose of the above-described organic salts is to give the hot-melt inks a certain stable value of electrical conductivity. Thus, their influence on other properties of the ink should be relatively inconsequential.

The following examples detail various additives and their influence on a variety of ink properties.

2.4.1 Viscosity

### EXAMPLE 12

Measurements of Viscosity of Various Solutions at 140° C.

Dynamic oscillatory shear time scans were performed with an Advanced Rheometric Expansion System (ARES) Rheometer from TA Instruments, Inc., using a Cone- and Plate geometry. The dynamic oscillatory shear time scans were performed at about 140° C. on all five solutions from Example 5, and on an Ink Carrier without a conductivity enhancing additive, using 50 mm diameter cone and plate combination of tools. Strain was about 70%, and the frequency was about 5 rad/s. Three measurements were done for each composition. The average complex viscosities are listed in Table 6.

TABLE 6

| Wt % Tri-Hexadecyl Ammonium-Trifluoro | Complex Viscosity, |
|---|---|
| Acetate | cP |
| 0.00 | 9.39 |
| 0.25 | 9.24 |
| 0.75 | 9.30 |
| 1.25 | 9.23 |
| 2.50 | 9.34 |
| 5.00 | 9.11 |

Previously, the complex viscosity of pure tri-hexadecyl ammonium-trifluoro acetate was been measured at about 140° C. using the same dynamic parameters. It was determined to be 5.90 centipoise (cP). Therefore, it could be expected that the new additive would have a viscosity-depressing influence in the ink base formulation.

The data in Table 6 demonstrates that tri-hexadecyl ammonium-trifluoro acetate has a very slight viscosity-lowering influence at 140° C., amounting to approximately 0.04 cP/wt %.

### EXAMPLE 13

Measurements of Viscosity of 5 Weight Percent Solutions in Magenta Ink at 110° C.

Steady shear rate ramp scans on an AR-1000 Rheometer from TA Instruments, Inc. were performed at about 110° C. on solutions from Example 6, which contained 5 weight percent of tri-hexadecyl ammonium-trifluoro acetate, tri-hexadecyl ammonium-methyl sulfonate, and tri-hexadecyl ammonium-trifluoromethyl sulfonate, and on magenta ink without a conductivity enhancing additive, using 40 mm diameter cone and plate combination of tools. The rate was changed between about 1000 and about 39 sec⁻¹. Two scans were measured on each mixture, and the average viscosity values are shown in Table 7 below.

TABLE 7

| | Viscosity, | Viscosity Increment, |
|---|---|---|
| Mixture | Centipoises | cP/wt % |
| Magenta Ink | 10.56 | — |
| 5 wt % Tri-Hexadecyl | 10.45 | −0.02 |
| Ammonium-Trifluoro | | |
| Acetate | | |
| 5 wt % Tri-Hexadecyl | 10.75 | +0.04 |
| Ammonium-Methyl | | |
| Sulfonate | | |
| 5 wt % Tri-Hexadecyl | 11.18 | +0.12 |
| Ammonium-Trifluoromethyl | | |
| Sulfonate | | |

Previously, shear viscosities of pure tri-hexadecyl ammonium-trifluoro acetate, tri-hexadecyl ammonium-methyl sulfonate, and tri-hexadecyl ammonium-trifluoromethyl sulfonate had been measured at about 110° C. Values of 10.8, 21.4, and 22.5 cP were determined, respectively. This data explains the positive and negative viscosity increments shown in Table 7. For tri-hexadecyl ammonium-trifluoro acetate, we see almost no impact on viscosity at about 110° C.

2.4.2 Glass Transition

### EXAMPLE 14

Measurements of Maximum in the Tan δ-Curve from DMA Scans of Various Solutions

Dynamic Mechanical Analysis (DMA) temperature scans using a RSA II Solids Analyzer (obtained from Rheometric Scientific) were performed at a frequency of 1 Hz on all five solutions from Example 5, and on a pure phase change ink carrier, using a dual cantilever geometry. Two measurements were done for each composition. Maxima in the tan δ vs. temperature curves were determined, and the temperatures at maximum were reported as glass transition temperatures. The average glass transition temperatures are listed below in Table 8.

TABLE 8

| Wt % Tri-Hexadecyl Ammonium-Trifluoro | |
|---|---|
| Acetate | T_{g}, C. ° |
| 0.00 | 13.1 |
| 0.25 | 12.7 |
| 0.75 | 11.8 |
| 1.25 | 11.0 |
| 2.50 | 10.5 |
| 5.00 | 9.8 |

The data in Table 8 shows, that there is a relatively strong lowering influence of tri-hexadecyl ammonium-trifluoro acetate on the glass transition temperature of the phase change ink carrier, amounting to approximately −0.61 K/wt % (Kelvin/weight percent). This additive effectively tends to soften the ink base. This is confirmed by lower measured elastic storage moduli (E′) in the solutions that contain such an additive, as compared to those measured in the unmodified ink base.

### EXAMPLE 15

Measurements of T_{g} by DMA of 5 Weight Percent Solutions in Magenta Ink

DMA temperature scans were performed at a frequency of 1 Hz on all three solutions from Example 6, which contained 5 weight percent of tri-hexadecyl ammonium-trifluoro acetate, tri-hexadecyl ammonium-methyl sulfonate, and tri-hexadecyl ammonium-trifluoromethyl sulfonate, and on the reference sample of magenta ink without a conductivity enhancing additive, using dual cantilever geometry. One scar, was measured on each mixture. The thermo-mechanical behavior of the ink is characterized by an existence of two maxima in the tan δ-curve, indicating two glass transition temperatures. Both glass transition temperatures, and their increment factors due to mixing with the additives are shown in Table 9.

TABLE 9

| | T_{g1}, | T_{g1} Increment, | T_{g2}, | T_{g2} Increment, |
|---|---|---|---|---|
| Mixture | ° C. | K/wt % | ° C. | K/wt % |
| Magenta Ink | −16.8 | — | 12.7 | — |
| 5 wt % | −12.8 | +0.80 | 9.7 | −0.60 |
| Tri-Hexadecyl | | | | |
| Ammonium-Trifluoro | | | | |
| Acetate | | | | |
| 5 wt % | −16.4 | +0.08 | 10.5 | −0.44 |
| Tri-Hexadecyl | | | | |
| Ammonium-Methyl | | | | |
| Sulfonate | | | | |
| 5 wt % | −15.1 | +0.34 | 12.0 | −0.14 |
| Tri-Hexadecyl | | | | |
| Ammonium- | | | | |
| Trifluoromethyl | | | | |
| Sulfonate | | | | |

The data from Table 9 suggests a strong influence of tri-hexadecyl ammonium-trifluoro acetate on the glass transition temperatures of an ink, and a relatively weak influence of tri-hexadecyl ammonium-trifluoromethyl sulfonate.

2.4.3 Toughness

Toughness is a desirable property of a solid ink, which is directly proportional to its durability when brought into contact with the media. In simple terms, the higher the toughness, the better the durability, and the better the performance of the ink on the media.

A measure for toughness is the area under the tan δ vs. temperature curve in a semi-logarithmic plot of DMA measurement results. The size of this calculated area is directly proportional to toughness.

### EXAMPLE 16

Measurements of Area Under the Tan δ-Curve from DMA Scans of Various Solutions

DMA temperature scans were performed at a frequency of 1 Hz on all five solutions from Example 5, and on pure phase change ink carrier, using dual cantilever geometry. Two measurements were done for each composition. The area under the tan δ vs. temperature curves was determined, and reported as a measure for ink toughness. The average areas under the respective curves are listed in Table 10 below.

TABLE 10

| Wt % Tri-Hexadecyl Ammonium-Trifluoro | |
|---|---|
| Acetate | Area |
| 0.00 | 23.2 |
| 0.25 | 22.3 |
| 0.75 | 24.0 |
| 1.25 | 21.5 |
| 2.50 | 23.8 |
| 5.00 | 21.1 |

The data in Table 10 shows that there is only a weak lowering influence of tri-hexadecyl ammonium-trifluoro acetate on the toughness of a phase change ink carrier, amounting to approximately −0.32 units/wt %. The additive had almost no influence on ink base toughness in the concentration interval under consideration, but it may make the ink base more brittle at concentrations that are above 5 weight percent.

### EXAMPLE 17

Measurements of Area Under the Tan δ-Curve from DMA Scans of 5 Weight Percent Solutions in Magenta Ink

DMA temperature scans were performed at a frequency of 1 Hz on all three solutions from Example 6, which contained 5 weight percent of tri-hexadecyl ammonium-trifluoro acetate, tri-hexadecyl ammonium-methyl sulfonate, and tri-hexadecyl ammonium-trifluoromethyl sulfonate, and on the reference sample of magenta ink without a conductivity enhancing additive, using dual cantilever geometry. One scan was measured on each mixture. The ink toughness was determined by integrating the area under the two maxima in the tan-curve, which were mentioned in Example 15. Ink toughness, and toughness increment factors due to mixing with the new additives are shown below in Table 11.

TABLE 11

| | Area, | Area Increment, |
|---|---|---|
| Mixture | arb. units | units/wt % |
| Magenta Ink | 14.8 | — |
| 5 wt % Tri-Hexadecyl | 13.8 | −0.20 |
| Ammonium-Trifluoro | | |
| Acetate | | |
| 5 wt % Tri-Hexadecyl | 13.2 | −0.32 |
| Ammonium-Methyl | | |
| Sulfonate | | |
| 5 wt % Tri-Hexadecyl | 15.9 | +0.22 |
| Ammonium-Trifluoromethyl | | |
| Sulfonate | | |

The data from Table 11 suggests a weak influence of all three additives on ink toughness, with a weak tendency of tri-hexadecyl ammonium-trifluoro acetate and tri-hexadecyl ammonium-methyl sulfonate to make the ink more brittle, and a weak tendency of tri-hexadecyl ammonium-trifluoromethyl sulfonate to make the ink tougher.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A phase change ink having an ink vehicle, at least one colorant and a conductivity enhancing agent, wherein the conductivity enhancing agent is an organic salt.

2. The ink according to claim 1, wherein the conductivity of the at least one phase change ink is in a range from about 0.01 μS/cm to about 5 μS/cm.

3. The ink according to claim 1, wherein the ink vehicle is a solid at a temperature below about 40° C. and has viscosity from about 1 to about 20 centipoise at a jetting temperature of from about 50° C. to about 150° C.

4. The ink according to claim 1, wherein the ink vehicle is selected from the group consisting of paraffins, microcrystalline waxes, polyethylene waxes, ester waxes, fatty acids and other waxy materials, fatty amide containing materials, sulfonamide materials, resinous materials made from tall oil rosins, resinous materials made from rosin esters, ethylene/propylene copolymers, urethane derivatives of oxidized synthetic or petroleum waxes, -paraffinic, branched paraffinic or naphthenic hydrocarbons, highly branched hydrocarbons, high molecular weight linear alcohols, hydrocarbon-based waxes, modified maleic anhydride hydrocarbon adducts of polyolefins and mixtures thereof.

5. The ink according to claim 1, wherein the organic salt is comprised of a molecular anion of an acid and a molecular cation of an organic base.

6. The ink according to claim 5, wherein the organic base is an organic amine.

7. The ink according to claim 6, wherein the organic amine has at least one carbon chain from about 10 carbons to about 50 carbons.

8. The ink according to claim 5, wherein the acid has a molecular weight from about 25 to about 250.

9. The ink according to claim 5, wherein the acid is trifluoroacetic acid, methane sulfonic acid or trifluoro methane sulfonic acid, and the organic base is tri-hexadecyl ammonium.

10. The ink according to claim 1, wherein the organic salt is miscible in the ink vehicle.

11. The ink according to claim 1, wherein the ink vehicle is from about 5 percent to about 99.5 percent by weight of the phase change ink, and the conductivity enhancing agent is from about 0.001 percent to about 8 percent by weight of the phase change ink.

12. The ink according to claim 1, wherein the organic salt is tri-hexadecyl ammonium-trifluoro acetate, tri-hexadecyl ammonium-methyl sulfonate, tri-hexadecyl ammonium-trifluoromethyl sulfonate or mixtures thereof.

13. The ink according to claim 1, wherein the organic salt is a tertiary ammonium salt.

14. The ink according to claim 1, wherein the at least one phase change ink further comprises one or more of a propellant, a biocide, a defoamer, a slip and leveling agent, a plasticizer, a pigment dispersant, a viscosity modifier, an antioxidant and an absorber.

15. The ink according to claim 1, wherein the organic salt is selected from the group consisting of a primary ammonium salt, a secondary ammonium salt, a tertiary ammonium salt, and any mixture thereof.

16. An ink jet system, comprising:
at least one phase change ink having an ink vehicle and a conductivity enhancing agent, wherein the conductivity enhancing agent is an organic salt; and
an ink jet device including an ink jet head consisting of one or more channels for the at least one phase change ink, and a supply path that supplies the at least one phase change ink to the one or more channels of the ink jet head from one or more reservoirs containing the at least one phase change ink, and wherein the one or more reservoirs includes a sensor to measure conductivity of the at least one phase change ink therein.

17. The ink jet system according to claim 16, wherein the ink jet device is a thermal ink jet device, an acoustic ink jet device or a piezoelectric ink jet device.

18. An ink jet system according to claim 16, wherein the ink jet device includes an intermediate transfer member, and the ink is ejected in an imagewise pattern onto the intermediate transfer member, and the ink in the imagewise pattern is subsequently transferred from the intermediate transfer member to a final recording substrate.

19. An ink jet system according to claim 16, wherein the conductivity of the at least one phase change in ink is in a range from about 0.01 μS/cm to about 5 S/cm.

20. An ink jet system according to claim 16, wherein the ink vehicle is a solid at a temperature below about 40° C. and has viscosity from about 1 to about 20 centipoise at a jetting temperature of from about 50° C. to about 150° C.

21. An ink jet system according to claim 16, wherein the organic salt is comprised of a molecular anion of an acid and a molecular cation of an organic base.

22. The ink jet system according to claim 21, wherein the organic base has at least one hydrocarbon chain having from about 10 carbon atoms to about 50 carbon atoms.

23. The ink jet system according to claim 16, wherein the ink vehicle is from about 5 percent to about 99.5 percent by weight of the phase change ink, and the conductivity enhancing agent is from about 0.001 percent to about 8 percent by weight of the phase change ink.

24. A method of forming an image, comprising:
heating a phase change ink in a reservoir, wherein the ink comprises an ink vehicle, at least one colorant and a conductivity enhancing agent, wherein the conductivity enhancing agent is an organic salt, and
jetting the heated ink onto an image receiving substrate, wherein the image receiving substrate is maintained at a second temperature at which the ink forms a gel,
wherein a reservoir has a sensor to measure the conductivity of the ink in the reservoir,
wherein the measured conductivity of the ink is compared against a value indicative of ink level in the reservoir, and
wherein addition of the ink into the reservoir is continued or stopped in response to the comparison of the measured conductivity to the value indicative of the ink level.
